(19) United States
(12) Patent Application Publication
(10) Pub. No.: US 2025/0289027 A1
(43) Pub. Date: Sep. 18, 2025

(54) METHOD OF MANUFACTURING GAS BARRIER FILM

(71) Applicant: FUJIFILM Corporation, Tokyo (JP)

(72) Inventors: Kenichi UMEMORI, Minamiashigara-shi (JP); Eijiro IWASE, Minamiashigara-shi (JP)

(73) Assignee: FUJIFILM Corporation, Tokyo (JP)

(21) Appl. No.: 19/225,428

(22) Filed: Jun. 2, 2025

Related U.S. Application Data
(63) Continuation of application No. PCT/JP2023/045940, filed on Dec. 21, 2023.

(30) Foreign Application Priority Data
Jan. 27, 2023 (JP) 2023-010793

(51) Int. Cl. B05D 3/12; B05D 1/28

(52) U.S. Cl. CPC B05D 3/12; B05D 1/28

(57) ABSTRACT

Provided is a method of manufacturing a gas barrier film where high barrier properties can be ensured on the entire surface of the gas barrier film in a case where a film is continuously formed on an elongated support through RtoR. Provided is a method of manufacturing a gas barrier film including an underlying organic layer and an inorganic layer on a resin support in this order, the method including: a cleaning step of removing foreign matter attached to the resin support before an application step of applying a coating liquid for forming the underlying organic layer; and an inspection step of inspecting the foreign matter attached to a formation surface of the resin support, in which in the inspection step, the foreign matter is inspected by scanning the formation surface of the resin support with inspection light and detecting light with a photodetector, the inspection light is incident into the formation surface of the resin support such that a scanning surface of the inspection light is orthogonal to each of the formation surface and a transport direction of the resin support, and the photodetector includes a light-receiving surface that is elongated in a direction orthogonal to the transport direction, and in a cross sectional view perpendicular to a width direction of the resin support, a line segment obtained by connecting a point where the formation surface and the scanning surface intersect each other to the light-receiving surface has an angle of 10° or less with respect to the formation surface.

### CROSS-REFERENCE TO RELATED APPLICATIONS

This application is a Continuation of PCT International Application No. PCT/JP2023/045940 filed on Dec. 21, 2023, which claims priority under 35 U.S.C. § 119(a) to Japanese Patent Application No. 2023-010793 filed on Jan. 27, 2023. The above applications are hereby expressly incorporated by reference, in their entirety, into the present application.

### BACKGROUND OF THE INVENTION

### 1. Field of the Invention

The present invention relates to a method of manufacturing a gas barrier film.

### 2. Description of the Related Art

As a gas barrier film with high gas barrier performance, a gas barrier film where an underlying organic layer and an inorganic layer are laminated on a support is known. In order to form the inorganic layer of the gas barrier film, film formation by a vacuum film forming method (vapor phase deposition) such as plasma chemical vapor deposition (plasma CVD) is suitably used from the viewpoints of film properties (barrier properties) and productivity.

In addition, as a film forming method having high productivity, so-called roll-to-roll (hereinafter, referred to as RtoR) is known. As is well-known, RtoR is a film forming method of feeding a support from a roll where the elongated support is wound in a roll shape, forming a film while transporting the support in a longitudinal direction, and winding the support on which the film is formed in a roll shape again.

In the gas barrier film where the underlying organic layer and the inorganic layer are laminated, in order to simultaneously exhibit high barrier properties and high transparency, the thickness of the inorganic layer that decreases a transmittance needs to be further reduced. However, in a case where the thickness of the inorganic layer is reduced, there is a concern that a discontinuous portion where the inorganic layer is not sufficiently formed due to unevenness of the support surface may occur such that barrier properties decrease. Therefore, inspection of foreign matter on the support surface before film formation is proposed.

For example, JP2008-107131A describes a foreign matter inspection method of inspecting foreign matter using a foreign matter inspection device including an irradiation unit, a light-receiving unit, and an image processing unit, the foreign matter being present on a surface of a sheet-shaped inspection object supported by a support member. In this method, the foreign matter includes X foreign matter having a large size and Y foreign matter having a small size, the irradiation unit includes a light source unit and a scanning unit, inspection light from the light source unit is emitted by the scanning unit in a tangential direction of the support member and the sheet-shaped inspection object at an angle of 80° to 90° with respect to a normal line at a contact between the support member and the sheet-shaped inspection object, the light-receiving unit includes a first light-receiving unit that is disposed at a position facing the inspection light and a second light-receiving unit that is disposed above a tangent line between the support member and the sheet-shaped inspection object, in the inspection light, refracted light that is emitted to the X foreign matter such that an optical path is bent is received by the first light-receiving unit, and scattered light that is emitted to the Y foreign matter and scattered is received by the second light-receiving unit, and information from the first light-receiving unit and the second light-receiving unit is analyzed by the image processing unit.

### SUMMARY OF THE INVENTION

However, according to an investigation by the present inventors, the following was found. In the foreign matter inspection method described in JP2008-107131A, an operation needs to be executed based on the information of the light received by the plurality of light-receiving units. Therefore, a large amount of image processing is required for the scattered light from the fine foreign matter, and high-speed processing is difficult. Therefore, it was found that, in a case where an elongated support is inspected through RtoR, the transportation speed needs to be set to be slower than that in a case where the underlying organic layer is formed through RtoR, and it is difficult to continuously inspect the entire surface of the support before film formation in a device for forming the underlying organic layer. Accordingly, high barrier properties cannot be ensured on the entire surface of the gas barrier film.

An object of the present invention is to solve the above-described problem of the related art and to provide a method of manufacturing a gas barrier film where high barrier properties can be ensured on the entire surface of the gas barrier film in a case where a film is continuously formed on an elongated support through RtoR.

In order to achieve the object, the present invention has the following configurations.
[1] A method of manufacturing a gas barrier film in which a gas barrier film including an underlying organic layer and an inorganic layer on a resin support in this order is prepared, the method comprising:
a cleaning step of removing foreign matter attached to the resin support
before an application step of applying a coating liquid for forming the underlying organic layer while transporting the elongated resin support in a longitudinal direction; and
an inspection step of inspecting the foreign matter attached to a formation surface of the resin support where the underlying organic layer is to be formed after the cleaning step,
in which in the inspection step, the foreign matter is inspected by scanning the formation surface of the resin support with inspection light and detecting light with a photodetector,
in the inspection step, the inspection light is incident into the formation surface of the resin support such that a scanning surface of the inspection light is orthogonal to each of the formation surface of the resin support and a transport direction of the resin support, and the photodetector includes a light-receiving surface that is elongated in a direction orthogonal to the transport direction, and in a cross sectional view perpendicular to a width direction of the resin support, a line segment obtained by connecting a point where the formation surface and the scanning surface intersect each other to the light-receiving surface has an angle of 10° or less with respect to the formation surface.
[2] The method of manufacturing a gas barrier film according to [1],
in which a reflectivity of the resin support with respect to light having a wavelength of the inspection light is 5% or less.
[3] The method of manufacturing a gas barrier film according to [1] or [2],
in which the inspection light is laser light.
[4] The method of manufacturing a gas barrier film according to [3],
in which an output of the laser light is 100 mW or more.

[5] The method of manufacturing a gas barrier film according to any one of [1] to [4],
in which in the inspection step, a surface of the resin support opposite to the formation surface is in contact with an air layer.
[6] The method of manufacturing a gas barrier film according to any one of [1] to [5],
in which the photodetector includes a light guide unit that consists of an optical fiber array and a photoelectric conversion element that receives light guided by the light guide unit.
[7] The method of manufacturing a gas barrier film according to any one of [1] to [6],
in which the inspection step is performed in an environment where a cleanliness class is 1000 or less and an air flow is 0.4 m/s or less.
[8] The method of manufacturing a gas barrier film according to any one of [1] to [7],
in which a transportation speed of the resin support is 10 m/min or more.
[9] The method of manufacturing a gas barrier film according to any one of [1] to [8],
in which the inspection light is incident into the resin support from the formation surface side.

[10] The method of manufacturing a gas barrier film according to any one of [1] to [9],
in which the cleaning step is performed at a position immediately upstream of a roller immediately upstream of a position where the inspection step is performed in the transport direction of the resin support.

According to the present invention, it is possible to provide a method of manufacturing a gas barrier film where high barrier properties can be ensured on the entire surface of the gas barrier film in a case where a film is continuously formed on an elongated support through RtoR.

### BRIEF DESCRIPTION OF THE DRAWINGS

FIG. 1 is a diagram conceptually showing an example of a film forming device that performs a method of manufacturing a gas barrier film according to the present invention.

FIG. 2 is a conceptual diagram showing an example of the method of manufacturing a gas barrier film according to the present invention.

FIG. 3 is a conceptual diagram showing an example of the method of manufacturing a gas barrier film according to the present invention.

FIG. 4 is a diagram conceptually showing an example of a gas barrier film prepared using the method of manufacturing a gas barrier film according to the present invention.

FIG. 5 is a perspective view conceptually showing an inspection unit in the film forming device shown in FIG. 1.

FIG. 6 is a front view showing a part of FIG. 5.

FIG. 7 is a perspective view conceptually showing an example of a photodetector in the inspection unit shown in FIG. 5.

### DESCRIPTION OF THE PREFERRED EMBODIMENTS

Hereinafter, a method of manufacturing a gas barrier film according to an embodiment of the present invention will be described in detail based on a preferred example shown in the accompanying drawings.

In the present invention, numerical ranges represented by “to” include numerical values before and after “to” as lower limit values and upper limit values.

In the present specification, for example, unless specified otherwise, an angle such as “45° ”, “parallel”, “perpendicular”, or “orthogonal” represents that a difference from an exact angle is less than 10 degrees. The difference from the exact angle is preferably less than 5 degrees and more preferably less than 3 degrees.

In the present specification, the terms such as “identical” and “the same” includes a range of an error generally accepted in the technical field.

### Method of Manufacturing Gas Barrier Film

The method of manufacturing a gas barrier film according to the embodiment of the present invention is
a method of manufacturing a gas barrier film in which a gas barrier film including an underlying organic layer and an inorganic layer on a resin support in this order is prepared, the method comprising:
a cleaning step of removing foreign matter attached to the resin support
before an application step of applying a coating liquid for forming the underlying organic layer while transporting the elongated resin support in a longitudinal direction; and
an inspection step of inspecting the foreign matter attached to a formation surface of the resin support where the underlying organic layer is to be formed after the cleaning step,
in which in the inspection step, the foreign matter is inspected by scanning the formation surface of the resin support with inspection light and detecting light with a photodetector,
in the inspection step, the inspection light is incident into the formation surface of the resin support such that a scanning surface of the inspection light is orthogonal to each of the formation surface of the resin support and a transport direction of the resin support, and
the photodetector includes a light-receiving surface that is elongated in a direction orthogonal to the transport direction, and in a cross sectional view perpendicular to a width direction of the resin support, a line segment obtained by connecting a point where the formation surface and the scanning surface intersect each other to the light-receiving surface has an angle of 10° or less with respect to the formation surface.

A configuration of a film forming device that performs the method of manufacturing a gas barrier film according to the embodiment of the present invention (hereinafter, also referred to as the manufacturing method according to the embodiment of the present invention) will be described.

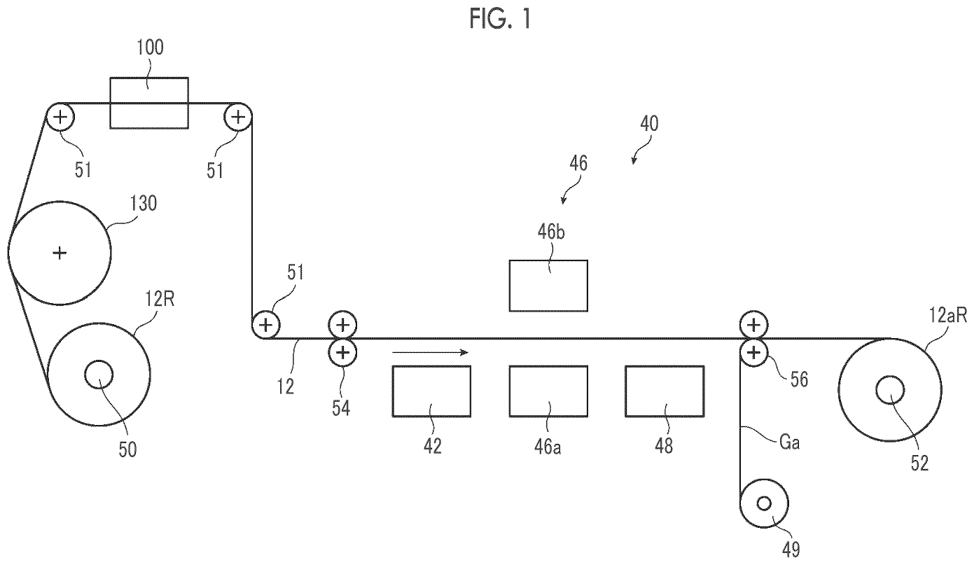

FIG. 1 conceptually shows an example of the film forming device that performs the method of manufacturing a gas barrier film according to the embodiment of the present invention.

An organic film forming device 40 shown in FIG. 1 forms an underlying organic layer 14 through RtoR, and applies a composition for forming an organic layer for forming the underlying organic layer 14 while transporting an elongated resin support (hereinafter, simply referred to as a support) 12 in a longitudinal direction, dries the applied composition for forming an organic layer, and polymerizes (cures) the organic compound in the composition for forming an organic layer by light irradiation to form the underlying organic layer 14. On a side upstream of a portion where the underlying organic layer 14 is formed, the organic film forming device 40 performs the removal step of removing attached to the support and the inspection step of inspecting the foreign matter on the surface of the support 12.

For example, the organic film forming device 40 shown in FIG. 1 includes a pressure-sensitive roller 130, an inspection unit 100, an application unit 42, a drying unit 46, a light irradiation unit 48, a rotating shaft 50, a winding shaft 52, transport roller pairs 54 and 56, and a plurality of transport rollers 51.

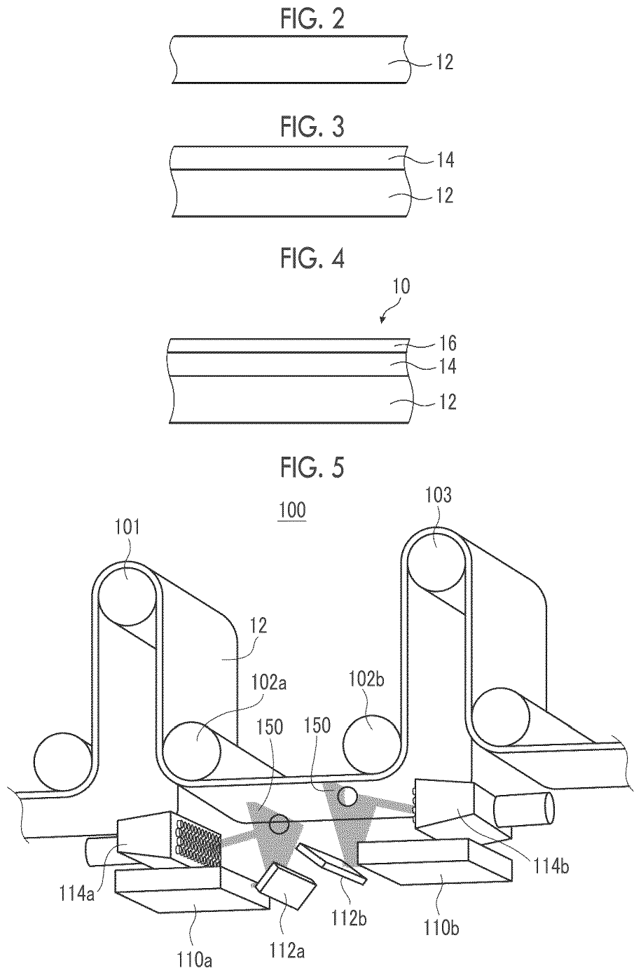

First, a support roll 12R obtained by winding the elongated support 12 is charged in the rotating shaft 50, and the support 12 (refer to FIG. 2) is drawn from the support roll 12R, is guided to the plurality of transport rollers 51 to pass the pressure-sensitive roller 130 and the inspection unit 100, passes the application unit 42, the drying unit 46, and the light irradiation unit 48 through the transport roller pair 54, and reaches the winding shaft 52 through the transport roller pair 56, that is, passes a predetermined transport path.

As the support 12, a well-known sheet-shaped material that is used as a support for various gas barrier films, various laminated functional films, and the like can be used. It is preferable that the support 12 has a thermal deformation.

Specifically, as the support 12, a resin film is preferably used. The material of the resin film is not particularly limited as long as the gas barrier film 10 is self-supported.

Examples of the resin film include films of polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), an acrylonitrile-butadiene-styrene copolymer (ABS), a cycloolefin copolymer (COC), a cycloolefin polymer (COP), and triacetyl cellulose (TAC).

The thickness of the support 12 can be appropriately set according to the application, the forming material, and the like. The thickness of the support 12 is preferably 5 to 150 um and more preferably 10 to 100 um from the viewpoint of sufficiently ensuring the mechanical strength of the gas barrier film 10, the viewpoint of reducing the weight and thickness of the gas barrier film 10, and the viewpoint of imparting the flexibility to the gas barrier film 10.

The support 12 drawn from the support roll 12R is transported to the pressure-sensitive roller 130 to perform the cleaning step in the present invention. Next, the support 12 is transported to the inspection unit 100 by the transport rollers 51 to perform the inspection step in the present invention. The configurations of the pressure-sensitive roller 130 and the inspection unit 100 will be described below.

The support 12 inspected in the inspection unit 100 is transported to the application unit 42, and the composition for forming an organic layer for forming the underlying organic layer 14 is applied to the surface.

The underlying organic layer 14 is formed, for example, by curing a composition for forming an organic layer, that includes an organic compound (a monomer, a dimer, a trimer, an oligomer, a polymer, and the like). The composition for forming an organic layer may include one kind or two or more kinds of organic compounds.

The underlying organic layer 14 includes, for example, a thermoplastic resin and an organic silicon compound. Examples of the thermoplastic resin include polyester, a (meth)acrylic resin, a methacrylic acid-maleic acid copolymer, polystyrene, a transparent fluororesin, polyimide, fluorinated polyimide, polyamide, polyamide imide, polyether imide, cellulose acylate, polyurethane, polyether ether ketone, polycarbonate, an alicyclic polyolefin, polyarylate, polyethersulfone, polysulfone, fluorene ring-modified polycarbonate, alicyclic-modified polycarbonate, fluorene ring-modified polyester, and an acrylic compound. Examples of the organic silicon compound include polysiloxane.

From the viewpoints of high strength and glass transition temperature, it is preferable that the underlying organic layer 14 includes a polymer of a radically curable compound and/or a cationically curable compound having an ether group.

From the viewpoint of reducing the refractive index of the underlying organic layer 14, it is preferable that the underlying organic layer 14 includes a (meth)acrylic resin including, as a major component, a polymer of a monomer, an oligomer, or the like of (meth)acrylate. By reducing the refractive index of the underlying organic layer 14, transparency increases, and a light-transmitting property is improved.

It is more preferable that the underlying organic layer 14 includes a (meth)acrylic resin including, as a major component, a monomer, a dimer, an oligomer, or the like of a bi-or higher functional (meth)acrylate such as dipropylene glycol di(meth)acrylate (DPGDA), trimethylolpropane tri(meth)acrylate (TMPTA), or dipentaerythritol hexa(meth)acrylate (DPHA), and it is still more preferable that the underlying organic layer 14 includes a (meth)acrylic resin including, as a major component, a polymer of a monomer or a polymer such as a dimer, an oligomer of a tri-or higher functional (meth)acrylate. In addition, a plurality of (meth)acrylic resins may be used. The major component refers to a component having the highest content mass ratio among components included.

It is preferable that the composition for forming an organic layer includes an organic solvent, a surfactant, and a silane coupling agent in addition to the organic compound.

As described below, in a case where a plurality of underlying organic layers 14 are provided, that is, in a case where plural sets of combinations of the underlying organic layers 14 and the inorganic layers 16 are provided, the materials of the underlying organic layers 14 may be the same as or different from each other.

The thickness of the underlying organic layer 14 is not limited and can be appropriately set according to components in the composition for forming an organic layer, the support 12 used, and the like.

The thickness of the underlying organic layer 14 is preferably 0.1 to 5 μm and more preferably 0.2 to 3 μm. It is preferable that the thickness of the underlying organic layer 14 is 0.1 μm or more from the viewpoint of embedding unevenness of the surface of the support 12, foreign matter attached to the surface, and the like such that the surface of the underlying organic layer 14 can be planarized. It is preferable that the thickness of the underlying organic layer 14 is 5 μm or less from the viewpoints that, for example, cracks of the underlying organic layer 14 can be prevented, the flexibility of the gas barrier film 10 can be improved, and the thickness and weight of the gas barrier film 10 can be reduced.

In a case where a plurality of underlying organic layers 14 are provided, that is, a case where plural sets of combinations of the inorganic layers 16 and the underlying organic layers 14 are provided, the thicknesses of the respective underlying organic layers 14 may be the same as or different from each other.

Various well-known methods such as a die coating method, a dip coating method, an air knife coating method, a curtain coating method, a roller coating method, a wire bar coating method, and a gravure coating method can be used for applying the composition for forming an organic layer in the application unit 42.

Next, the support 12 to which the composition for forming an organic layer that forms the underlying organic layer 14 is heated by the drying unit 46 to remove the organic solvent, and dry the composition for forming an organic layer.

In the example shown in FIG. 1, the drying unit 46 includes a drying unit 46a that performs heating and drying from the front surface side (the composition for forming an organic layer (the formation surface side of the underlying organic layer 14 or the like)) and a drying unit 46b that performs heating and drying from the back surface side of the support 12, and dries the composition for forming an organic layer from both of the front surface side and the back surface side.

Heating in the drying unit 46 may be performed using a well-known method for heating a sheet-shaped material. For example, the drying unit 46a on the front surface side is a hot-air drying unit, and the drying unit 46b on the back surface side can be a heating roller (a guide roller having a heating mechanism).

Next, the support 12 in which the composition for forming an organic layer that forms the underlying organic layer 14 is dried is irradiated with ultraviolet rays or the like by the light irradiation unit 48 such that the organic compound is polymerized (crosslinked) and cured to form the underlying organic layer 14. As a result, a laminate shown in FIG. 3 including the underlying organic layer 14 on the support 12 is obtained. Further, optionally, the curing of the organic compound that forms the underlying organic layer 14 may be performed in an inert atmosphere such as a nitrogen atmosphere.

The support 12 on which the underlying organic layer 14 is formed is transported by the transport roller pair 56 and wound into a roll shape by the winding shaft 52. Here, in the transport roller pair 56 of the organic film forming device 40, a protective film Ga fed from a supply roll 49 is laminated on the underlying organic layer 14 to protect the underlying organic layer 14.

In a case where the formation of the underlying organic layer 14 having a predetermined length is finished, the support 12 is optionally cut. Next, the laminate of the underlying organic layer 14, the support 12, and the protective film Ga is wound in a roll shape to form a support roll 12aR.

Next, the support roll 12aR is supplied to an inorganic film forming device for forming the inorganic layer, and is provided for forming the inorganic layer 16. In the inorganic film forming device, the inorganic layer 16 is formed on the underlying organic layer 14, and the gas barrier film 10 shown in FIG. 4 including the support 12, the underlying organic layer 14, and the inorganic layer 16 in this order is prepared.

As a method of forming the inorganic layer that is performed in the inorganic film forming device, for example, plasma CVD such as capacitively coupled plasma (CCP)-chemical vapor deposition (CVD) or inductively coupled plasma (ICP)-CVD, atomic layer deposition (ALD), sputtering such as magnetron sputtering or reactive sputtering, or various vapor deposition methods such as vacuum deposition can be suitably used.

In addition, as a material of the inorganic layer formed in the inorganic film forming device, various inorganic compounds that are used for a well-known gas barrier layer consisting of an inorganic compound exhibiting gas barrier properties can be used.

Examples of a material of the inorganic layer 16 include inorganic compounds, for example, a metal oxide such as aluminum oxide, magnesium oxide, tantalum oxide, zirconium oxide, titanium oxide, or indium tin oxide (ITO); a metal nitride such as aluminum nitride; a metal carbide such as aluminum carbide; a silicon oxide such as silicon oxide, silicon oxynitride, silicon oxycarbide, or silicon oxynitride-carbide; a silicon nitride such as silicon nitride or silicon nitride-carbide; a silicon carbide such as silicon carbide; a hydride thereof; a mixture of two or more kinds thereof; and a hydrogen-containing material thereof. In addition, a mixture of two or more kinds of the examples can be used.

In particular, silicon nitride, silicon oxide, silicon oxynitride, aluminum oxide, or a mixture of two or more kinds thereof is preferably used from the viewpoints that transparency is high and excellent gas barrier properties can be exhibited. In particular, a compound including silicon is preferably used, and silicon nitride is more preferably used from the viewpoint that excellent gas barrier properties can be exhibited.

The thickness of the inorganic layer 16 is not particularly limited and can be appropriately set depending on materials such that desired gas barrier properties can be exhibited.

The thickness of the inorganic layer 16 is preferably 10 to 150 nm, more preferably 12 to 100 nm, and still more preferably 15 to 75 nm.

It is preferable that the thickness of the inorganic layer 16 is 10 nm or more from the viewpoint that the inorganic layer 16 stably exhibiting sufficient gas barrier performance can be formed. In addition, in a case where the inorganic layer 16 is generally brittle and is excessively thick, breakage, cracking, peeling, or the like may occur. However, by adjusting the thickness of the inorganic layer 16 to be 150 nm or less, the occurrence of breakage can be prevented.

As described below, in a case where a plurality of inorganic layers 16 are provided, the thicknesses of the inorganic layers 16 may be the same as or different from each other.

In addition, in a case where a plurality of inorganic layers 16 are provided, the materials of the inorganic layers 16 may be the same as or different from each other.

In the example shown in FIG. 4, the prepared gas barrier film 10 includes the support 12, the underlying organic layer 14, and the inorganic layer 16 but is not limited thereto. Further, a protective organic layer for protecting the inorganic layer 16 may be provided on the inorganic layer 16. In addition, in the example shown in FIG. 4, the gas barrier film 10 includes one combination of the underlying organic layer 14 and the inorganic layer 16 but is not limited thereto. The gas barrier film 10 may include two or more combinations of the underlying organic layers 14 and the inorganic layers 16.

A method of forming the underlying organic layer and the inorganic layer of the gas barrier film can refer to the method of forming the underlying organic layer and the inorganic layer through RtoR described in JP2013-166298A.

Next, the pressure-sensitive roller 130 that performs the cleaning step will be described.

The pressure-sensitive roller 130 includes a pressure-sensitive adhesive layer having pressure-sensitive adhesiveness on a peripheral surface of a cylindrical member. By winding the support 12 to be transported around the peripheral surface of the pressure-sensitive roller 130, foreign matter attached to the surface (hereinafter, referred to as the formation surface) of the support 12 where the underlying organic layer is to be formed is removed. That is, the support 12 is wound around the pressure-sensitive roller 130 such that the formation surface faces the pressure-sensitive roller 130.

An adhesive strength of the pressure-sensitive roller 130 is preferably 50 Pa to 200 Pa. For example, an adhesive strength of 100 Pa can be used.

A method of performing the cleaning step in the manufacturing method according to the embodiment of the present invention is not limited to the method of using the pressure-sensitive roller 130, and a well-known method of removing foreign matter from a resin film surface in the related art can be appropriately used. For example, in addition to the film contact type rubber roller cleaning method that is used at this time, for example, an ultrasonic dry air cleaning method of ultrasonically blowing air at a high pressure or a wet cleaning method of using water or a chemical can be used.

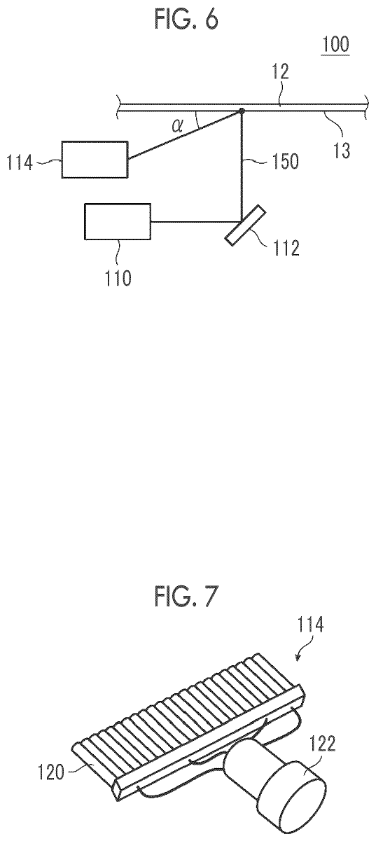

Next, the inspection unit 100 in the organic film forming device 40 will be described using FIGS. 5 and 6.

FIG. 5 is a perspective view conceptually showing the inspection unit 100 in the organic film forming device 40 shown in FIG. 1. FIG. 6 is an enlarged front view showing a part of FIG. 5 (view from the width direction of the support 12).

The inspection unit 100 shown in FIG. 5 includes a laser light source 110a, a scanning unit 112a, a photodetector 114a, a laser light source 110b, a scanning unit 112b, a photodetector 114b, and transport rollers 101, 102a, 102b, and 103.

In the example shown in FIG. 5, the laser light source 110a, the scanning unit 112a, and the photodetector 114a inspects foreign matter in a region that is about half of the support 12 in the width direction (depth side in the direction perpendicular to the paper plane in FIG. 5), and the laser light source 110b, the scanning unit 112b, and the photodetector 114b inspects foreign matter in the remaining region that is about half of the support 12 in the width direction (front side in the direction perpendicular to the paper plane in FIG. 5). That is, the laser light source 110a, the scanning unit 112a, and the photodetector 114a configure one inspection device, and the laser light source 110b, the scanning unit 112b, and the photodetector 114b configure one inspection device.

The laser light source 110a and the laser light source 110b basically have the same configuration, except that the dispositions are different. Therefore, in the following description, the laser light source 110a and the laser light source 110b will also be collectively referred to as the laser light source 110. Likewise, the scanning unit 112a and the scanning unit 112b basically have the same configuration, except that the dispositions are different. Therefore, in the following description, the scanning unit 112a and the scanning unit 112b will also be collectively referred to as the scanning unit 112. Likewise, the photodetector 114a and the photodetector 114b basically have the same configuration, except that the dispositions are different. Therefore, in the following description, the photodetector 114a and the photodetector 114b will also be collectively referred to as the photodetector 114.

The support 12 that performs the cleaning step in the pressure-sensitive roller 130 is transported in the inspection unit 100 along the predetermined transport path by the transport rollers 101, 102a, 102b, and 103.

The laser light source 110a, the scanning unit 112a, and the photodetector 114a and the laser light source 110b, the scanning unit 112b, and the photodetector 114b are disposed on a path between the transport roller 102a and the transport roller 102b to perform the inspection step.

Specifically, as shown in FIGS. 5 and 6, the laser light source 110, the scanning unit 112, and the photodetector 114 are disposed on the formation surface side of the support 12, the laser light source 110 emits light (inspection light) in a direction substantially parallel to the transport direction of the support 12, and the scanning unit 112 reflects the inspection light toward the support 12 to deflect the light for scanning in the width direction of the support 12 (direction perpendicular to the paper plane in FIG. 6).

In a case where foreign matter is present at a position irradiated with the inspection light on the formation surface of the support 12, a part of the inspection light is scattered by the foreign matter, a part of the scattered light is incident into the photodetector 114, and the photodetector 114 detects a part of the scattered light. Whether foreign matter on the formation surface is present, the size thereof, and the like can be estimated from the detection result of the light by the photodetector 114. In addition, while transporting the support 12, the detection of the foreign matter is performed, and thus the entire surface of the support 12 can be sequentially inspected.

Here, in the manufacturing method according to the embodiment of the present invention, in the inspection step that is performed as described above, the inspection light is incident into the formation surface of the support 12 such that a scanning surface of the inspection light is orthogonal to each of the formation surface of the support 12 and the transport direction of the support 12. Further, the photodetector 114 includes a light-receiving surface that is elongated in a direction orthogonal to the transport direction of the support 12, that is, in the width direction of the support 12, and in a cross sectional view perpendicular to the width direction of the support 12, a line segment obtained by connecting a point where the formation surface of the support 12 and the scanning surface intersect each other to the light-receiving surface of the photodetector 114 has an angle of 10° or less with respect to the formation surface.

In the present invention, regarding the scanning surface and the inspection surface being orthogonal to each other and the scanning surface and the transport direction being orthogonal to each other, the difference from the exact angle is within a range of less than 10 degrees and is preferably less than 5 degrees and more preferably less than 3 degrees.

Here, in the present invention, the scanning surface refers to a surface that is defined by a trajectory of the inspection light incident into the support 12 by scanning as indicated by reference numeral 150 in FIG. 5. That is, in the example shown in FIG. 5, the scanning surface 150 is a planar region surrounded by lines obtained by connecting a point of the scanning unit 112 where the inspection light is incident from the laser light source 110 to one end point and the other end point on a line on the support 12 where the inspection light is scanned.

In the manufacturing method according to the embodiment of the present invention, as shown in FIG. 6, the inspection light is scanned by the scanning unit 112 such that the scanning surface 150 is orthogonal to the formation surface 13 of the support 12 (surface perpendicular to the vertical direction in FIG. 6) and is orthogonal to the transport direction of the support 12 (left-right direction in FIG. 6). In other words, in a cross sectional view perpendicular to the width direction of the support 12, the inspection light is substantially vertically incident into the formation surface 13 of the support 12.

In addition, as shown in FIG. 5, the photodetector 114 is disposed such that the light-receiving surface faces the scanning surface 150 side. The light-receiving surface of the photodetector 114 is elongated in the direction orthogonal to the transport direction of the support 12, that is, in the width direction of the support 12, and is disposed such that the elongated direction and the width direction of the support 12 substantially match with each other. Accordingly, as shown in FIG. 6, the photodetector 114 is disposed such that the light-receiving surface is substantially parallel to the scanning surface 150.

In addition, as shown in FIG. 6, the photodetector 114 is disposed such that, in the cross sectional view perpendicular to the width direction of the support 12, the line segment obtained by connecting the point where the formation surface 13 of the support 12 and the scanning surface 150 intersect each other to the light-receiving surface of the photodetector 114 has an angle α of 10° or less with respect to the formation surface 13. In a case where the light-receiving surface of the photodetector 114 has a height (width in the vertical direction in FIG. 6, the angle α is 10° or less at all the positions of the light-receiving surface. In the following description, the angle a will also be referred to as the mounting angle of the photodetector 114.

In the inspection unit 100 configured as described above, the laser light source 110 emits the inspection light (laser light) to the scanning unit 112, and the scanning unit 112 deflects the inspection light to the support 12 for scanning while reflecting the inspection light. At a position where foreign matter is not present, the inspection light emitted to the support 12 substantially transmits through the transparent support 12, and a part of the inspection light is reflected from the air interface or the like but is reflected in a direction substantially perpendicular to the formation surface 13. Therefore, the inspection light is not substantially incident into the photodetector 114 having a mounting angle of 10° or less. Accordingly, the absence of foreign matter at the position of the formation surface 13 of the support 12 to which the inspection light is emitted can be detected.

On the other hand, at a position where foreign matter is present, a part of the inspection light emitted to the support 12 is scattered by the foreign matter in various directions. A part of the scattered light is also incident into the photodetector 114 at a mounting angle of 10° or less. Accordingly, in a case where the photodetector 114 receives the inspection light, the presence of foreign matter at the position of the formation surface 13 of the support 12 to which the inspection light is emitted can be detected. That is, the light detected by the photodetector 114 can also be considered the scattered light by the foreign matter.

In addition, the light-receiving surface of the photodetector 114 is elongated in the width direction of the support 12, and is disposed parallel to the width direction of the support 12. The scattered light is incident from various positions of the light-receiving surface, and as the distance from the scattered light, that is, the foreign matter decreases, a higher light intensity can be detected. That is, the photodetector 114 detects a higher light intensity at the same position as the position of the foreign matter in the width direction. Therefore, the position and/or size of the foreign matter on the support 12 can be detected from the light intensity distribution in the width direction of the scattered light received by the photodetector 114.

As described above, In the foreign matter inspection method in the related art, an operation needs to be executed based on the information of the light received by the plurality of light-receiving units. Therefore, there is a problem in that a large amount of image processing is required for the scattered light from the fine foreign matter, and high-speed processing is difficult. Therefore, it was found that, in a case where an elongated support is inspected through RtoR, the transportation speed needs to be set to be slower than that in a case where the underlying organic layer is formed through RtoR, and it is difficult to continuously inspect the entire surface of the support before film formation in a device for forming the underlying organic layer. Accordingly, high gas barrier properties cannot be ensured on the entire surface of the gas barrier film.

On the other hand, in the manufacturing method according to the embodiment of the present invention, in a cross sectional view perpendicular to the width direction of the support 12, the inspection light is substantially vertically incident into the formation surface 13 of the support 12, and the mounting angle α of the photodetector 114 is 10° or less. As a result, only the scattered light by the foreign matter can be detected by the photodetector 114, and in a case where the light is received by the photodetector 114, the presence of foreign matter can be detected. In addition, the position and/or size of the foreign matter can be detected from the light intensity distribution in the width direction of the scattered light received by the photodetector 114. Therefore, complicated processing such as image processing is unnecessary, and high-speed processing can be performed. Accordingly, the transportation speed can be increased. Therefore, in a device for forming the underlying organic layer through RtoR, the entire surface of the support can be continuously inspected before forming the underlying organic layer. Accordingly, high gas barrier properties can be ensured on the entire surface of the gas barrier film.

In addition, in the manufacturing method according to the embodiment of the present invention, the cleaning step is performed before the inspection step. Therefore, in the inspection step, foreign matter that cannot be removed in the cleaning step and is strongly attached to the support 12 is detected. The strongly attached foreign matter is likely to cause a decrease in the gas barrier performance of the gas barrier film. Therefore, by detecting the strongly attached foreign matter, the gas barrier performance of the gas barrier film can be ensured.

In addition, in the manufacturing method according to the embodiment of the present invention, the application step of applying the coating liquid for forming the underlying organic layer is performed after the inspection step. Since whether or not the foreign matter detected in the inspection step can be embedded in the underlying organic layer can be determined, the gas barrier performance of the gas barrier film can be ensured.

In the present invention, the inspection result of foreign matter can be used for various kinds of processing. For example, a region where foreign matter that decreases the gas barrier performance is detected may be specified to remove the region from the prepared gas barrier film such that only a region where high gas barrier performance can be ensured is used. Alternatively, a region where foreign matter that decreases the gas barrier performance is detected may be used as a gas barrier film having low gas barrier performance. Alternatively, in a case where foreign matter that decreases the gas barrier performance is detected on the entire surface, the support itself may be considered a defective product.

Alternatively, in a case where foreign matter that decreases the gas barrier performance is detected, a configuration of performing a second cleaning step may be adopted. Alternatively, depending on the detection result of the foreign matter, the thickness of the underlying organic layer to be formed may be configured to be changeable to a thickness where the foreign matter can be embedded.

Here, from the viewpoint of the detection accuracy of foreign matter, the mounting angle a of the photodetector 114 is more than 0° and 10° or less, preferably 1° to 5°, and more preferably 2° to 3.5°.

In addition, assuming that the transportation speed in the inspection step is the same as the transportation speed during the formation of the underlying organic layer, from the viewpoint of continuously performing the inspection step and the formation of the underlying organic layer through RtoR, the transportation speed of the support 12 is preferably 10 m/min or more, more preferably 15 m/min to 40 m/min, and still more preferably 20 m/min to 40 m/min.

In addition, in the support 12 used in the manufacturing method according to the embodiment of the present invention, a reflectivity with respect to light having a wavelength of the inspection light is preferably 5% or less, more preferably 4.5% or less, and still more preferably 4.3% or less. As a result, the photodetector 114 can suppress reception of light other than the scattered light by foreign matter, and the detection of foreign matter can be performed with higher accuracy.

In a case where unpolarized light in a wavelength range including the wavelength of the inspection light is incident from a direction of 5° with respect to the normal direction of the surface of the support and a transmission spectrum is measured using a spectrophotometer (V-670, manufactured by JASCO Corporation), the reflectivity of the support can be calculated from Reflectivity=1−Transmittance.

In addition, as shown in FIG. 5, it is preferable that, in the inspection step, a surface of the support 12 opposite to the formation surface at the position where the inspection light is emitted is in contact with an air layer. For example, in a case where the inspection light is emitted to the support 12 at a position where the support 12 is wound around the roller, light transmitted through the support 12 is reflected from the surface of the roller, and a part of the transmitted light may be incident into the photodetector 114. That is, the photodetector 114 may detect light other than the scattered light by foreign matter. Therefore, the detection accuracy of foreign matter decreases. On the other hand, with the configuration where the surface of the support 12 opposite to the formation surface is in contact with the air layer at the position where the inspection light is emitted, the detection by the photodetector 114 for the light other than the scattered light by foreign matter can be suppressed, and foreign matter can be detected with higher accuracy.

In addition, it is preferable that the inspection step is performed in an environment where a cleanliness class is 1000 or less and an air flow is 0.4 m/s or less. It is more preferable that the cleaning step, the inspection step, and the application step of applying the coating liquid for forming the underlying organic layer are performed in an environment where a cleanliness class is 1000 or less and an air flow is 0.4 m/s or less.

As described above, in the inspection step, foreign matter that cannot be removed in the cleaning step and is strongly attached to the support 12 is detected. However, in a period from the cleaning step to the inspection step or from the inspection step to the application step, new foreign matter may be attached to the support. The gas barrier performance may decrease due to newly attached foreign matter, and the ensuring accuracy of the gas barrier performance by the inspection result in the inspection step may decrease. On the other hand, by performing the inspection step in the environment where the cleanliness class is 1000 or less and the air flow is 0.4 m/s or less, attachment of new foreign matter to the support can be suppressed, and the ensuring accuracy of the gas barrier performance by the inspection result in the inspection step can be increased.

In addition, in the example shown in FIGS. 5 and 6, the inspection light is incident into the support 12 from the formation surface 13 side of the support 12. However, the present invention is not limited to this configuration, and the inspection light may be incident into the support 12 from the back surface side opposite to the formation surface 13. From the viewpoint of the detection accuracy of foreign matter, it is preferable that the inspection light is incident into the support 12 from the formation surface 13 side of the support 12.

In addition, in the manufacturing method according to the embodiment of the present invention, it is preferable that the cleaning step is performed at a position immediately upstream of a roller immediately upstream of a position where the inspection step is performed in the transport direction of the support 12. For example, in the example shown in FIG. 5, it is preferable that the cleaning step is performed between the transport roller 102a that is a roller immediately upstream of the position where the inspection step is performed and the transport roller 101 upstream of the transport roller 102a. Alternatively, in the example shown in FIG. 5, a pressure-sensitive roller for performing the cleaning step may be disposed at the position of the transport roller 101.

In addition, in the example shown in FIG. 5, the inspection unit 100 includes two combinations of the laser light sources 110, the scanning units 112, and the photodetectors 114 that are arranged in the width direction of the support 12. However, the present invention is not limited to this configuration. For example, the inspection unit 100 may include one combination of the laser light source 110, the scanning unit 112, and the photodetector 114. In this case, the scanning unit 112 scans the entire region in the width direction of the support 12 with the inspection light. In addition, the inspection unit 100 may include three or more combinations of the laser light sources 110, the scanning units 112, and the photodetectors 114. In a case where the inspection unit 100 includes a plurality of combinations of the laser light sources 110, the scanning units 112, and the photodetectors 114, a scanning range by a plurality of scanning units 112 may be the entire region in the width direction of the support 12. In addition, light-receiving surfaces of a plurality of photodetectors 114 may be disposed on the entire region in the width direction of the support 12.

In addition, the inspection unit 100 is also not limited to the configuration where it includes the same number of the laser light sources 110, the scanning units 112, and the photodetectors 114. For example, one laser light source 110 and one scanning unit 112 may be provided, one scanning unit 112 may scan the entire region in the width direction of the support 12 with the inspection light, and the scattered light may be detected by a plurality of photodetectors 114 arranged in the width direction of the support 12. A plurality of laser light sources 110 and a plurality of scanning units 112 may be provided, the scanning range of the inspection light by the plurality of scanning units 112 may be included in the entire region in the width direction of the support 12, and the scattered light may be detected by one photodetector 114 having a plurality of light-receiving surfaces having widths that are more than or equal to the width of the support 12. Alternatively, different numbers of the laser light sources 110, the scanning units 112, and the photodetectors 114 may be provided, the scanning range of the inspection light by the plurality of scanning units 112 may be included in the entire region in the width direction of the support 12, and the scattered light may be detected by a plurality of photodetectors 114 arranged in the width direction of the support 12.

The laser light source 110 is a light source that emits the inspection light. In the example shown in the drawing, a laser light source is used as the light source. However, the present invention is not limited thereto, and a well-known light source such as a light emitting diode (LED), an organic light emitting diode (OLED), a vertical cavity surface emitting laser (VCSEL), a globar, a xenon lamp, or a halogen lamp can be used. As the light source, a light source that emits light having a single wavelength may be used depending on sensitivity properties of the photodetector. By using the light source that emits light having a single wavelength, light acting as noise other than the scattered light by foreign matter can be reduced by cutting light having a wavelength other than the wavelength in the light incident into the photodetector.

In addition, the wavelength of the light emitted from the light source is not particularly limited and is preferably 300 nm to 900 nm and more preferably 600 nm to 700 nm.

The output of the laser light source is preferably 100 mW or more, more preferably 100 mW to 300 mW, and still more preferably 200 mW to 300 mW. By increasing the output, the scattered light by foreign matter can be more suitably detected.

In addition, a laser light source is preferably used from the viewpoints that light having a unit wavelength can be emitted and the output can be increased.

The scanning unit 112 is a unit that deflects incident light for scanning while reflecting the light. Examples of the scanning unit include well-known scanning devices in the related art such as a galvano mirror, a polygon mirror, or a micro electro mechanical system (MEMS).

The photodetector 114 is a sensor including a photoelectric conversion element that receives incident light. The photodetector 114 may include various functional films such as a lens or a color filter in addition to the photoelectric conversion element.

As the photoelectric conversion element in the photodetector 114, a well-known imaging element in the related art such as a charge-coupled device (CCD) image sensor or a complementary metal oxide semiconductor (CMOS) image sensor can be used. In addition, the photodetector 114 may be a line sensor in which a plurality of pixels are one-dimensionally (linearly) arranged, or may be a two-dimensional sensor in which a plurality of pixels are two-dimensionally arranged.

Here, it is preferable that the photodetector 114 includes a light guide unit that consists of an optical fiber array and a photoelectric conversion element that receives light guided by the light guide unit.

FIG. 7 is a perspective view conceptually showing an example of the photodetector 114.

The photodetector 114 shown in FIG. 7 includes an optical fiber array 120 where one edge surfaces of a plurality of optical fibers are two-dimensionally arranged and a photoelectric conversion element 122 that is disposed on the other edge surface side of the optical fibers.

The optical fiber array 120 guides incident light from one edge surface to the other edge surface such that the light is incident into a pixel of a predetermined position of the photoelectric conversion element 122 for each of the optical fibers. A surface of the optical fiber array 120 where the one edge surfaces are arranged is the light-receiving surface of the photodetector 114.

With the configuration where the photodetector includes a light guide unit that consists of an optical fiber array and a photoelectric conversion element that receives light guided by the light guide unit, incident light can be received by the optical fibers without a gap such that high-sensitivity light-receiving can be performed.

As the optical fiber array 120, for example, an optical fiber array where optical fibers having a core diameter of 190 um and a fiber diameter of 200 um are arrayed can be used.

In addition, in the optical fiber array 120, a plurality of optical fibers may be combined halfway a path. In this case, an optical scanning position can be seen at a timing at which the photodetector detects light. Therefore, the position of foreign matter can be specified.

Hereinbefore, the method of manufacturing a gas barrier film according to the embodiment of the present invention has been described in detail. However, the present invention is not limited to the above-described aspects and various improvements and changes may be made within a range not departing from the scope of the present invention.

### EXPLANATION OF REFERENCES

10: gas barrier film
12: support
12R: support roll
12aR: laminate roll
14: underlying organic layer
16: inorganic layer
40: organic film forming device
42: application unit
46: drying unit
48: light irradiation unit
49: supply roll
50: rotating shaft
51, 101, 102a, 102b, 103: transport roller
52: winding shaft
54, 56: transport roller pair
100: inspection unit
110, 110a, 110b: laser light source
112, 112a, 112b: scanning unit
114, 114a, 114b: photodetector
120: optical fiber array
122: photoelectric conversion element
130: pressure-sensitive roller
150: scanning surface
Ga: protective film
α: angle

What is claimed is:

1. A method of manufacturing a gas barrier film in which a gas barrier film including an underlying organic layer and an inorganic layer on a resin support in this order is prepared, the method comprising:
a cleaning step of removing foreign matter attached to the resin support
before an application step of applying a coating liquid for forming the underlying organic layer while transporting the elongated resin support in a longitudinal direction; and
an inspection step of inspecting the foreign matter attached to a formation surface of the resin support where the underlying organic layer is to be formed after the cleaning step,
wherein in the inspection step, the foreign matter is inspected by scanning the formation surface of the resin support with inspection light and detecting light with a photodetector,
in the inspection step, the inspection light is incident into the formation surface of the resin support such that a scanning surface of the inspection light is orthogonal to each of the formation surface of the resin support and a transport direction of the resin support, and
the photodetector includes a light-receiving surface that is elongated in a direction orthogonal to the transport direction, and in a cross sectional view perpendicular to a width direction of the resin support, a line segment obtained by connecting a point where the formation surface and the scanning surface intersect each other to the light-receiving surface has an angle of 10° or less with respect to the formation surface.

2. The method of manufacturing a gas barrier film according to claim 1,
wherein a reflectivity of the resin support with respect to light having a wavelength of the inspection light is 5% or less.

3. The method of manufacturing a gas barrier film according to claim 1,
wherein the inspection light is laser light.

4. The method of manufacturing a gas barrier film according to claim 3,
wherein an output of the laser light is 100 mW or more.

5. The method of manufacturing a gas barrier film according to claim 1,
wherein in the inspection step, a surface of the resin support opposite to the formation surface is in contact with an air layer.

6. The method of manufacturing a gas barrier film according to claim 1,
wherein the photodetector includes a light guide unit that consists of an optical fiber array and a photoelectric conversion element that receives light guided by the light guide unit.

7. The method of manufacturing a gas barrier film according to claim 1,
wherein the inspection step is performed in an environment where a cleanliness class is 1000 or less and an air flow is 0.4 m/s or less.

8. The method of manufacturing a gas barrier film according to claim 1,
wherein a transportation speed of the resin support is 10 m/min or more.

9. The method of manufacturing a gas barrier film according to claim 1,
wherein the inspection light is incident into the resin support from the formation surface side.

10. The method of manufacturing a gas barrier film according to claim 1,
wherein the cleaning step is performed at a position immediately upstream of a roller immediately upstream of a position where the inspection step is performed in the transport direction of the resin support.

11. The method of manufacturing a gas barrier film according to claim 2,
wherein the inspection light is laser light.

12. The method of manufacturing a gas barrier film according to claim 11,
wherein an output of the laser light is 100 mW or more.

13. The method of manufacturing a gas barrier film according to claim 2,
wherein in the inspection step, a surface of the resin support opposite to the formation surface is in contact with an air layer.

14. The method of manufacturing a gas barrier film according to claim 2,
wherein the photodetector includes a light guide unit that consists of an optical fiber array and a photoelectric conversion element that receives light guided by the light guide unit.

15. The method of manufacturing a gas barrier film according to claim 2,
wherein the inspection step is performed in an environment where a cleanliness class is 1000 or less and an air flow is 0.4 m/s or less.

16. The method of manufacturing a gas barrier film according to claim 2,
wherein a transportation speed of the resin support is 10 m/min or more.

17. The method of manufacturing a gas barrier film according to claim 2,
wherein the inspection light is incident into the resin support from the formation surface side.

18. The method of manufacturing a gas barrier film according to claim 2,
wherein the cleaning step is performed at a position immediately upstream of a roller immediately upstream of a position where the inspection step is performed in the transport direction of the resin support.

19. The method of manufacturing a gas barrier film according to claim 4,
wherein in the inspection step, a surface of the resin support opposite to the formation surface is in contact with an air layer.

20. The method of manufacturing a gas barrier film according to claim 4,
wherein the photodetector includes a light guide unit that consists of an optical fiber array and a photoelectric conversion element that receives light guided by the light guide unit.
